(19) United States
(12) Patent Application Publication
(10) Pub. No.: US 2026/0117971 A1
(43) Pub. Date: Apr. 30, 2026

(54) FUEL DELIVERY

(71) Applicant: Illinois Tool Works Inc., Glenview, IL (US)

(72) Inventor: Christophe DESPESSE, Saint-Romain de Lerps (FR)

(21) Appl. No.: 19/368,373

(22) Filed: Oct. 24, 2025

(30) Foreign Application Priority Data
Oct. 24, 2024 (FR) 2411638
Oct. 9, 2025 (EP) 25207693.0

(51) Int. Cl. F23N 1/00; B25C 1/18

(52) U.S. Cl. CPC F23N 1/005; B25C 1/18

(57) ABSTRACT

Fuel dosing system for a fastening tool such as a nailer, said system comprising a fuel reservoir and a dosing unit configured to be filled from the fuel reservoir with a preset dose of fuel and, upon a single activation of the fastening tool, to enable the preset dose of fuel to be delivered to a combustion chamber on the fastening tool.

### PRIORITY CLAIM

This patent application claims priority to and the benefit of French Patent Application No. 2411638, filed Oct. 24, 2024, and European Patent Application No. 25207693.0, filed Oct. 9, 2025, the entire contents of each of which are incorporated herein by reference.

### TECHNICAL FIELD

The present disclosure relates to combustion-powered fastening tools, that is, tools that operate with a combustion chamber to which fuel is delivered, such as a nailer. In particular, the present disclosure relates to a fluid fuel dosing system for such a fastening tool. The present disclosure aims to provide a dosing system that can be incorporated into the fuel delivery mechanism on the tool upstream of the combustion chamber.

### TECHNICAL BACKGROUND

Fluid delivery systems such as the ones described in U.S. Pat. No. 6,302,297 and EP Patent No. EP0597241 enable fuel to be delivered from a reservoir, for example contained in a cartridge, to the combustion chamber on the tool, via a mechanically actuated valve, for a period of time set by a timer.

Since fuel is continuously injected for the amount of time set by the timer for the fuel delivery system to be open, any blockage or delay in this system will result in an excessive amount of fuel being delivered to the combustion chamber, which, in addition to emptying the reservoir, can disrupt the operation of the tool.

### SUMMARY

The present disclosure aims to remedy at least some of the aforementioned drawbacks and to provide a dosing system that is both easy and reliable to use.

The present disclosure therefore relates to a fuel dosing system for a fastening tool such as a nailer, comprising a dosing unit configured to enable a preset dose of fuel to be delivered from a fuel reservoir to a combustion chamber on the tool in a single activation of the tool.

Preferably, the system comprises a dosing unit that enables dosing to be activated by an inner drawer and by a first inlet chamber formed between the drawer and said dosing unit, and an outlet chamber, the inner drawer having at least one filling position in which the first inlet chamber is fluidly connected to the reservoir so that it can be filled with fluid during fluid connection while the outlet chamber is fluidly disconnected from the combustion chamber on the tool, and a delivery position in which, conversely, the first inlet chamber is fluidly disconnected from the reservoir and the outlet chamber is fluidly connected to the combustion chamber.

In the first embodiment, the system can further comprise a second inlet chamber with a volume different from that of the first inlet chamber, making it possible to deliver a second dose different from the first dose from the first inlet chamber when the system is switched to the filling position.

Advantageously, the movement of the drawer in the unit is electrically activated by an electrical control signal emitted by a control module.

For example, the drawer is connected to an electromagnet configured so that it can push or pull the unit toward either of the two filling positions.

Advantageously, the system comprises a solenoid valve, a solenoid, and/or at least one resilient return member for keeping the drawer in position in the unit, such that the delivery position corresponds to a system release position.

In a second embodiment, it can be provided that dosing the fuel from the reservoir to the combustion chamber takes place in a dosing unit on the tool, in which screening is carried out by an etched disc positioned between an inlet and an outlet on said dosing unit and rotated for a time pulse corresponding to the movement of the etched disc between an angular position in which the cavities are filled with fuel from the inlet on the unit and a position in which the fuel is delivered from the cavities to the outlet on the unit, the filling of the cavities corresponding to a preset dose.

The system can further provide that, in the first or second embodiment, the dose is adjusted by a number of electrical pulses actuating the dosing system.

Preferably, the fastening tool is a nailer.

The present disclosure also relates to a fastening tool comprising the fuel dosing system.

Advantageously, the dosing system further comprises an etched disc positioned between an inlet on the unit and an outlet on the unit, in which said preset dose of fuel is delivered from the reservoir to the combustion chamber on the tool by screening it through said etched disc.

Advantageously, the dosing system comprises an etched disc configured to be rotated for a time interval corresponding to a displacement of the etched disc between an angular position in which the cavities of the etched disc are filled with fuel from the inlet on the unit and a position in which the fuel is delivered from the cavities to the outlet on the unit, the filling of the cavities corresponding to a preset dose.

Advantageously, the dosing system further comprises one or more complementary screen discs sealingly positioned downstream of the etched disc in order to ensure the closing or opening of the cavities in the etched disc to respectively allow or prevent the flow of a preset dose of fuel toward the outlet on the unit.

Advantageously, the dosing system comprises contact surfaces between discs provided with sealing mechanism between them and with the unit so as to prevent leaks when the system is in operation.

Advantageously, the dosing system comprises an etched disc driven by a user, when the tool is actuated, by a drive mechanism such as a gear.

Advantageously, the dosing system is configured to be adjusted by one or more electrical pulses.

Advantageously, the dosing system comprises said one or more electrical pulses configured to actuate the dosing system a preset number of times to deliver a preset amount of fuel to the combustion chamber.

The present disclosure also relates to a fastening tool comprising a dosing system as previously described.

Advantageously, the fastening tool is a nailer.

### BRIEF DESCRIPTION OF THE SEVERAL VIEW OF THE FIGURES

The present disclosure will be better understood from a detailed study of two embodiments taken as non-limiting examples and illustrated by the appended drawings.

FIG. 1 schematically shows the architecture of the tool of one embodiment of the present disclosure.

FIG. 2 shows the dosing system according to a first embodiment of the present disclosure, with a drawer.

FIG. 3 and FIG. 4 show the dosing system according to a second embodiment of the present disclosure, with a disc.

### DETAILED DESCRIPTION

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

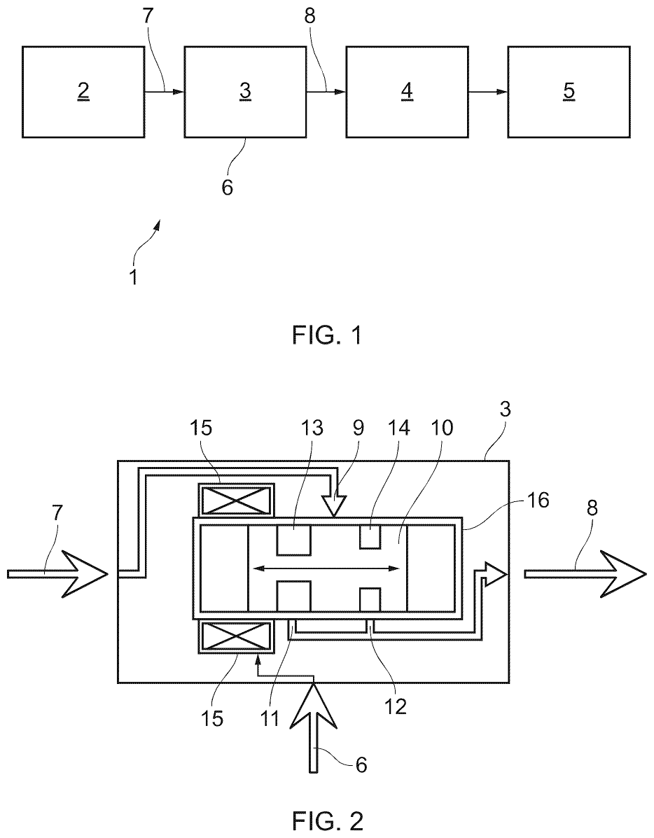

FIG. 1 schematically shows the fastening tool as a whole, with a reservoir 2 for storing fuel and a combustion chamber 4 in which the fuel is burned when the tool is in operation, to actuate a piston or cylinder 5 in order to fire the tool, for example to eject a nail, staple, punch, etc.

The dosing system 1 according to the present disclosure is positioned between the fuel reservoir 2 and the combustion chamber 4, to which it is fluidly connected upstream and downstream, respectively, by its inlet 7 and by its outlet 8.

The fuel used is in a fluid state in the reservoir, for example stored as a gas such as liquefied petroleum gas, known by the acronym “LPG,” or any other liquid or gaseous fuel.

In all of the embodiments, the fuel dosing system 1 for the fastening tool is configured to allow a preset amount of fuel to be delivered from a fuel reservoir 2 to the combustion chamber 4 on the tool in a single activation of the tool.

It therefore acts as a volumetric valve for dosing this fuel, and constitutes a mechanism that prevents continuous fuel leaks in the event of failure, since the fuel is not injected through the continuous opening of a valve for a given period of time that might be unintentionally extended but is injected in doses at each pulse of the expected electrical control signal 6.

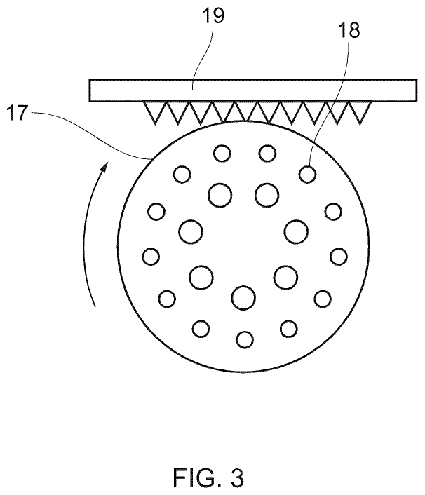

In the first embodiment illustrated in FIG. 2, system 1 comprises a dosing unit 3 for activating dosing by way of an inner drawer 10 that is translationally connected to the unit 3 and sealed thereto in a sump 16, for the fuel in question.

The drawer dosing system 10 comprises a first inlet chamber 13 formed between the drawer 10 and said dosing unit 3, and an outlet chamber 14.

The inner drawer 10 has at least one filling position in which the first inlet chamber is fluidly connected to the reservoir 2 so that it can be filled with fluid during fluid connection, while the outlet chamber 14 is fluidly disconnected from the combustion chamber 4 on the tool.

The inner drawer 10 also has a delivery position in which, contrary to the filling position, the first inlet chamber 13 is fluidly disconnected from the reservoir 2 and the outlet chamber 14 is fluidly connected to the combustion chamber via at least one outlet 11, 12 on the chambers 13, 14 and then the outlet 8 on the unit 3.

Thus, in the filling position, the pressurized fuel flows from the reservoir to the inlet on the dosing unit, where it can enter via an inlet 7.9 on the unit 3 and fill the first inlet chamber, which corresponds to a preset dose of fuel to be used in the combustion chamber, depending on the desired power of the tool, on its low or high operating temperature range, and on the fuel used.

Thus, when using, for example, a fuel with a so-called broad flammability range, that is, for example, with a lower flammability limit of five percent in air and an upper flammability limit of seventy-five percent, two ejection powers can be provided using this dosing system 1.

In the first embodiment, the system 1 can further comprise a second filling chamber 14 with a volume different from that of the first inlet chamber, making it possible to deliver a second dose different from the first dose to the inlet chamber when the system is switched to the filling position.

The system then comprises two filling positions, for selectively filling either the first filling chamber or the second filling chamber.

As illustrated in FIG. 2, the first or second filling chamber is selected, for example, according to the direction in which the sliding mechanism in the drawer is actuated: downstream, namely toward the reservoir, to position the inlet on the unit opposite the first filling chamber, so as to fluidly connect this chamber to the reservoir, or upstream, namely toward the combustion chamber, so as to position the inlet on the unit opposite the second filling chamber and fluidly connect them.

This thus results in a first filling position and a second filling position, which makes it possible to provide for two different fuel doses and thus create a tool that can be used in two modes, for example to distinguish between two operating temperature ranges or two operating power levels.

The user can thus adapt the tool to the environment in which it is used, to the chosen fuel in the tool, and to the materials on which the tool is used.

Advantageously, the movement of the drawer in the unit is electrically activated by an electrical control signal emitted by a control module.

Dosing can thus be done using smaller doses applied several times according to a preset frequency signal.

In the event of a failure, and unlike the systems used in the tools in the prior art, this dosing system keeps the fuel from leaking out of the reservoir and downstream of said dosing system, in particular toward the combustion chamber, since the drawer, which is fuel-tight relative to the unit, forms a barrier to its spread toward the outlet on the unit, whether there is a blockage in the filling position or in the delivery position.

For example, the drawer is connected to an electromagnet configured so that it can push or pull the unit toward either of the two filling positions.

This type of linear actuator enables bidirectional actuation of the drawer.

For example, the solenoid is arranged around the unit and the electromagnet is positioned on the upstream side of the drawer, that is, closer to the reservoir than to the combustion chamber, so as to free the latter from any encumbrance.

As an alternative, a plurality of solenoids, for example two, can be used, operating for example in opposition, one for pushing and the other for pulling the drawer.

Advantageously, the system comprises a solenoid valve, a solenoid, and/or at least one resilient return member for keeping the drawer in position in the unit, such that the delivery position corresponds to a system release position.

Fuel from the reservoir therefore only moves into the unit and into the first or second inlet chamber when the tool is actuated, corresponding to a control signal from the dosing system to move the drawer to the filling position, then returning it to the delivery position, which sends the preset dose of fuel to the combustion chamber and prevents any further movement of the fuel or of the drawer once the fuel is in the combustion chamber.

The system thus comprises two possible actuations corresponding to two opposite directions of movement of the drawer, for example according to a positive pulse or according to a negative pulse from an electrical control signal emitted by the control module.

This makes the tool safer by preventing any further actuation once the fuel has been sent to the combustion chamber from the delivery position, since this corresponds to the neutral position of the tool.

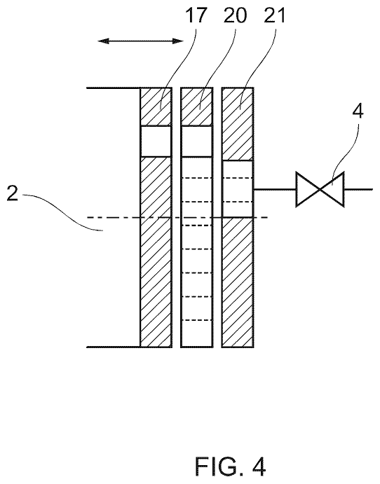

In a second embodiment illustrated in FIGS. 3 and 4, it can be provided that dosing fuel from the reservoir to the combustion chamber takes place in a dosing unit on the tool, in which screening is carried out by an etched disc 17.

Such an etched disc is positioned between an inlet and an outlet on the dosing unit and can rotate freely around an axis of the unit, forming a sealed connection with said unit.

The etched disc is configured so that it can be rotated for a time pulse corresponding to a displacement of the etched disc between an angular position in which the cavities of the etched disc are filled with fuel from the inlet on the unit and a position in which the fuel is delivered from the cavities 18 to the outlet on the unit, the filling of the cavities corresponding to a preset dose.

For example, it can be provided that the etched disc 17 is coupled with a complementary screen disc or several screen discs 20, 21 located directly behind it in a sealed connection and enables the cavities to be closed or opened to allow or prevent the delivery of a preset dose of fuel between the upstream and downstream sides of these discs.

The screen disc is the disc 20 containing the cavities 18 and several complementary discs 17, 21, respectively the inlet disc 17 containing an inlet port and the outlet disc 21 containing an outlet port, are fixed in the system 1, while the disc 20 can be rotated, which makes it possible to alternately align one of its cavities 18 with the inlet port on the fixed disc 17, then with the outlet port on the fixed disc 21, so as to dose fuel from and to the outlet on the unit 3, which can be activated and cannot be closed in the continuous fuel delivery position between the reservoir 2 and the combustion chamber 4, as is the case in the first embodiment.

In this second embodiment, the contact surfaces between the discs 17, 20, and 21 are provided with the sealing mechanism between them and with the unit 3, preventing leaks throughout all operating phases of the system 1.

The etched disc is, for example, rotated electrically or manually by the user when the tool is actuated, for example by a drive mechanism 19 which can be a gear mechanism.

The system 1 can further provide that, in the first or in the second embodiment, the dose is adjusted by a number of electrical pulses actuating the dosing system a preset number of times to deliver a preset amount of fuel to the combustion chamber.

The present disclosure also relates to a fastening tool comprising the fuel dosing system 1.

Preferably, the fastening tool is a nailer.

A fastening tool is thus produced with a dosing system that makes it possible to measure the fuel dose to the combustion chamber into a chamber or into cavities, with a preset volume temporarily stored in a movable part and which is sent to the combustion chamber when the components of the dosing system are aligned with the delivery position under the impulse of an electrical control signal, which can enable the tool to be provided with two different modes.

1. A fuel dosing system for a fastening tool, said system comprising:
a fuel reservoir; and
a dosing unit fillable from the fuel reservoir with a preset dose of fuel, wherein upon a single activation of the fastening tool, the dosing unit enables the preset dose of fuel to be delivered to a combustion chamber of the fastening tool.

2. The dosing system of claim 1, wherein the dosing unit includes an inner drawer translationally movable in the dosing unit to enable the fuel to be dosed.

3. The dosing system of claim 2, wherein the inner drawer includes a first inlet chamber formed between the inner drawer and the dosing unit to store the preset dose and an outlet chamber.

4. The dosing system of claim 3, wherein the inner drawer is movable to:
a filling position at which the first inlet chamber is fluidly connected to the fuel reservoir and the outlet chamber is fluidly disconnected from the combustion chamber, and
a delivery position at which the first inlet chamber is fluidly disconnected from the fuel reservoir and the outlet chamber is fluidly connected to the combustion chamber.

5. The dosing system of claim 3, which includes a second inlet chamber having a volume different than the first inlet chamber such that a second preset dose of fuel that is different from the first preset dose is deliverable when the dosing system is in the filling position.

6. The dosing system of claim 2, which enables electrical activation of the movement of the inner drawer in the dosing unit by an electrical control signal emitted by a control module.

7. The dosing system of claim 3, wherein the inner drawer is connected to an electromagnet positioned to push or pull the dosing unit toward the filling position.

8. The dosing system claim 4, which includes a solenoid valve, a solenoid, and/or a resilient return member positioned to keep the inner drawer in position in the dosing unit such that the delivery position corresponds to a dosing system release position.

9. The dosing system of claim 1, which includes an etched disc positioned between an inlet on the dosing unit and an outlet on the dosing unit, wherein the preset dose of fuel is delivered from the fuel reservoir to the combustion chamber by screening the fuel through the etched disc.

10. The dosing system of claim 9, wherein the etched disc is rotatable for a time interval corresponding to a displacement of the etched disc between an angular position in which cavities of the etched disc are filled with fuel from the inlet and a position in which the fuel is delivered from the cavities to the outlet, and wherein the filling of the cavities correspond to the preset dose.

11. The dosing system of claim 10, which includes a complementary screen disc sealingly positioned downstream of the etched disc to ensure closing or opening of the cavities of the etched disc to respectively allow or prevent flow of the preset dose of fuel toward the outlet.

12. The dosing system of claim 11, which includes a sealing mechanism adjacent the disc.

13. The dosing system of claim 10, wherein the etched disc is driven when the fastening tool is actuated by a drive mechanism thereof.

14. The dosing system of claim 1, which is adjustable by one or more electrical pulses.

15. The dosing system of claim 14, wherein the one or more electrical pulses are configured to actuate the dosing system a preset quantity of times to deliver the preset dose of fuel to the combustion chamber.
